(19) United States
(12) Patent Application Publication
(10) Pub. No.: US 2021/0347376 A1
(43) Pub. Date: Nov. 11, 2021

(54) AUTONOMOUS DRIVER-FEEDBACK SYSTEM AND METHOD

(71) Applicant: STEERING SOLUTIONS IP HOLDING CORPORATION, Saginaw, MI (US)

(72) Inventors: Joachim J. Klesing, Rochester, MI (US); Ayyoub Rezaeian, Troy, MI (US); Pierre C. Longuemare, Paris (FR)

(21) Appl. No.: 16/869,583

(22) Filed: May 7, 2020

(51) Int. Cl. B60W 60/00; B60W 50/10; B60W 40/08; B60W 50/16; G05D 1/00

(52) U.S. Cl. CPC B60W 60/001; B60W 50/10; B60W 40/08; G05D 2201/0213; G05D 1/0088; B60W 2540/043; B60W 50/16

(57) ABSTRACT

A system and method for providing autonomous control of a vehicle. The system and method comprising a processor and a memory including instructions executable by the processor. The processor identifying at least one data input of a route of autonomous travel by a vehicle and receive a first autonomous action for controlling autonomous travel of the vehicle. The processor determine a second autonomous action for controlling autonomous travel of the vehicle based on the at least one data input. The processor generating a selectable output that includes the first autonomous action and the second autonomous action. The processor receives an input indicating a selected one of the first autonomous action and the second autonomous action and selectively control autonomous travel of the vehicle based on the selected one of the first autonomous action and the second autonomous action.

### TECHNICAL FIELD

This disclosure relates to a steering system and particularly to autonomous control of a steering system of a vehicle.

### BACKGROUND OF THE INVENTION

Vehicles such as cars, trucks, sport utility vehicles, crossovers, mini-vans, or other suitable vehicles are increasingly being provided with autonomous systems. For example, vehicles may include autonomous systems configured to autonomously control the vehicle. In order to control operation of the vehicle, the autonomous system may utilize various information, such as vehicle geometric parameters (e.g., length, width, and height), vehicle inertia parameters (e.g., mass, center of gravity location along a longitudinal axis, and yaw moment of inertia) and the proximate environment of vehicle. Autonomous systems are configured to analyze and use data representative of the geometric parameters, inertia parameters and proximate environment of vehicle to control the vehicle. During operation of the vehicle, geometric parameters generally remain constant and may be monitored via an image capturing device, such as a camera. However, inertia parameter values generally change over time (e.g., during vehicle operation), especially for large vehicles (e.g., large trucks).

In certain autonomous systems, such as semi-autonomous systems, the driver may provide instructions to the autonomous system to control the vehicle. Moreover, the driver may override the semi-autonomous system to take manual control of the vehicle. In such instances, the driver's instructions or override may interrupt the semi-autonomous system and/or its control of the vehicle, resulting in a hazardous condition to the vehicle and/or driver. On the other hand, pure-autonomous systems do not require driver input and may control the vehicle without the risk of interruption by driver input or override. Many drivers, however, are hesitant to relinquish control of the vehicle to a pure-autonomous system.

### SUMMARY OF THE INVENTION

An aspect of the disclosed embodiments includes, a system provides autonomous control of a vehicle. The system may include a processor and a memory. The memory includes instructions that, when executed by the processor, cause the processor to: identify at least one data input of a route of autonomous travel by a vehicle; receive a first autonomous action for controlling autonomous travel of the vehicle, the first autonomous action being determined based on the at least one data input; determine a second autonomous action for controlling autonomous travel of the vehicle based on the at least one data input, the second autonomous action including at least one steering maneuver; generate a selectable output that includes the first autonomous action and the second autonomous action; receive an input indicating a selected one of the first autonomous action and the second autonomous action; and selectively control autonomous travel of the vehicle based on the selected one of the first autonomous action and the second autonomous action.

Another aspect of the disclosed embodiments includes a method is for providing autonomous control of a vehicle. The method includes identifying at least one data input of a route of autonomous travel by a vehicle and receiving a first autonomous action for controlling autonomous travel of the vehicle, the first autonomous action being determined based on the at least one data input. The method may include the step of determining a second autonomous action for controlling autonomous travel of the vehicle based on the at least one data input, and the second autonomous action including at least one steering maneuver. The method may include generating a selectable output that includes the first autonomous action and the second autonomous action and receiving an input signal corresponding to a selected one of the first autonomous action and the second autonomous action. The method may include controlling autonomous vehicle travel based on the selected one of the first autonomous action and the second autonomous action.

Another aspect of the disclosed embodiments includes an apparatus for providing autonomous control of a vehicle. The apparatus may include a controller that includes a processor and a memory that may include instructions that, when executed by the processor, cause the processor to: identify at least one data input of a route of autonomous travel by a vehicle; receive a first autonomous action for controlling autonomous travel of the vehicle, the first autonomous action being determined based on the at least one data inputs; determine a second autonomous action for controlling autonomous travel of the vehicle based on the at least one data input, the second autonomous action including at least one steering maneuver; generate a selectable output that includes the first autonomous action and the second autonomous action to an occupant of the vehicle; receive an input from the occupant including a selected one of the first autonomous action and the second autonomous action; selectively control autonomous vehicle operation based on the selected one of the first autonomous action and the second autonomous action; and provide instructions to an autonomous controller of the vehicle based on the selected one of the first autonomous action and the second autonomous action.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a vehicle according to the principles of the present disclosure.

FIG. 2 generally illustrates a system for providing autonomous control of a vehicle according to the principles of the present disclosure.

FIG. 3 is a flow diagram generally illustrating a method for providing autonomous control of a vehicle according to the principles of the present disclosure.

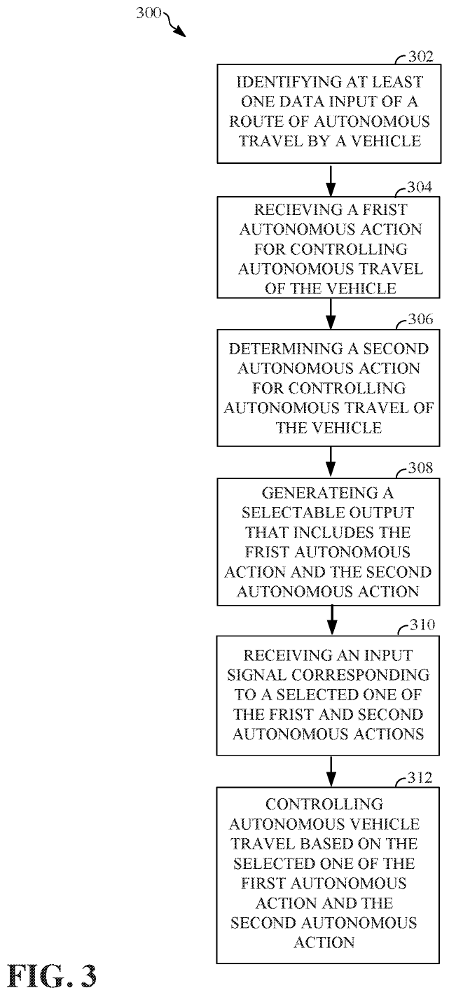

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, vehicles such as cars, trucks, sport utility vehicles, crossovers, mini-vans, or other suitable vehicles are increasingly being provided with autonomous systems. For example, vehicles may include autonomous systems configured to autonomously control the vehicle. In order to control operation of the vehicle, the autonomous system may utilize various information, such as vehicle geometric parameters (e.g., length, width, and height), vehicle inertia parameters (e.g., mass, center of gravity location along a longitudinal axis, and yaw moment of inertia) and the proximate environment of vehicle. During operation of the vehicle, geometric parameters generally remain constant and may be monitored via an image capturing device, such as a camera. However, inertia parameter values generally change over time (e.g., during vehicle operation), especially for large vehicles (e.g., large trucks). Autonomous systems are configured to analyze and use data representative of the geometric parameters, inertia parameters and proximate environment of vehicle to control the vehicle.

In certain autonomous systems, such as semi-autonomous systems, the driver may provide instructions to the autonomous system to control the vehicle. Moreover, the driver may override the semi-autonomous system to take manual control of the vehicle. In such instances, a risk exist that the driver's instructions or override may interrupt the semi-autonomous system and its control of the vehicle, resulting in a hazardous condition to the vehicle and/or driver. On the other hand, pure-autonomous systems do not require driver input and may control the vehicle without the risk of interruption by driver input or override.

Many drivers, however, are hesitant to relinquish control of the vehicle to a pure-autonomous system. Accordingly, systems and methods, such as the systems and methods described herein, may be configured to provide a pure-autonomous system that recognizes, analyzes, and uses driver input while maintaining complete control of the vehicle to prevent inadvertent interruption of control of the vehicle and/or human error.

The systems and methods described herein may be configured to provide autonomous control of the vehicle by realizing dynamic behavior of the vehicle, driver preference, and an environment proximate the vehicle. Dynamic behavior of vehicles is typically affected by both vehicle geometric parameters (e.g., length, width, and height) and inertia parameters (e.g., mass, center of gravity location along a longitudinal axis, and yaw moment of inertia). Under most operating conditions, geometric parameters are constant and may be monitored via an image-capturing device, such as a camera. On the other hand, the environment proximate to the vehicle frequently changes over time along with the inertia parameter values. Relying on the image-capturing device, other sensors, or a driver preference, the system may monitor the environment proximate to the vehicle in real-time. For example, the system may be configured to monitor for potholes, objects, pedestrians, flow of traffic, or road surface conditions, and the like. The systems and methods described herein may be configured to monitor vehicle inertia parameter values (e.g., mass, center of gravity location along longitudinal axis, and yaw moment of inertia) in real time using various vehicle sensors and lateral dynamic values (e.g., yaw rate and acceleration).

In some embodiments, the systems and methods described herein may be configured to utilize driver preference, the vehicle's geometric parameters, inertia parameters, and proximate environment, to provide autonomous control of the vehicle. To provide a driver of the vehicle with a feeling, or sense, of autonomy over the vehicle, the system may communicate with, or receive a preference from, a driver of the vehicle. Although the system of the present disclosure may communicate with the driver of the vehicle, the system is configured to maintain autonomous control of the vehicle. That is, the driver's communication does not override or control the system of the vehicle. Instead, the driver communication provides a suggestion, preference, and/or guidance, but not a command.

In some embodiments, the system and methods described herein may be configured to maintain autonomous control of the vehicle while providing communication with a driver to receive suggestions, preference, and/or guidance from the driver to provide the driver with a feeling of autonomy over the vehicle. In some embodiments, the systems and methods described herein may comprise a controller, a processor, and a memory including instructions. In some embodiments, the instructions of the systems and methods described herein, when executed by the processor, may cause the processor to identify a data input of a route of autonomous travel. In some embodiments, the identification of the at least one data input of a route of autonomous travel by the vehicle may include identification of a signal from a driver, or user. The signal may represent an input of the at least one data input of a route of autonomous travel. In some embodiments, the at least one data input of a route of autonomous travel by the vehicle may be based on a preference of a user for autonomous travel of the vehicle. In some embodiments, the instructions of the systems and methods described herein may cause the processor to receive a first autonomous action, based on the data input, for controlling autonomous travel of the vehicle. In some embodiments, the instructions of the systems and methods described herein may cause the processor to determine a second autonomous action, including a steering maneuver and based on the data input, for controlling autonomous travel of the vehicle.

In some embodiments, the instructions of the systems and methods described herein may cause the processor to generate a selectable output that includes the first autonomous action and the second autonomous action. In some embodiments, the instructions of the systems and methods described herein may cause the processor to receive an input indicating a selected one of the first autonomous action and the second autonomous action. In some embodiments, the instructions of the systems and methods described herein may cause the processor to selectively control autonomous travel of the vehicle based on the selected one of the first autonomous action and the second autonomous action. In some embodiments, the instructions of the systems and methods described herein may cause the processor to provide instructions to an autonomous controller of the vehicle based on the selected one of the first autonomous action and the second autonomous action.

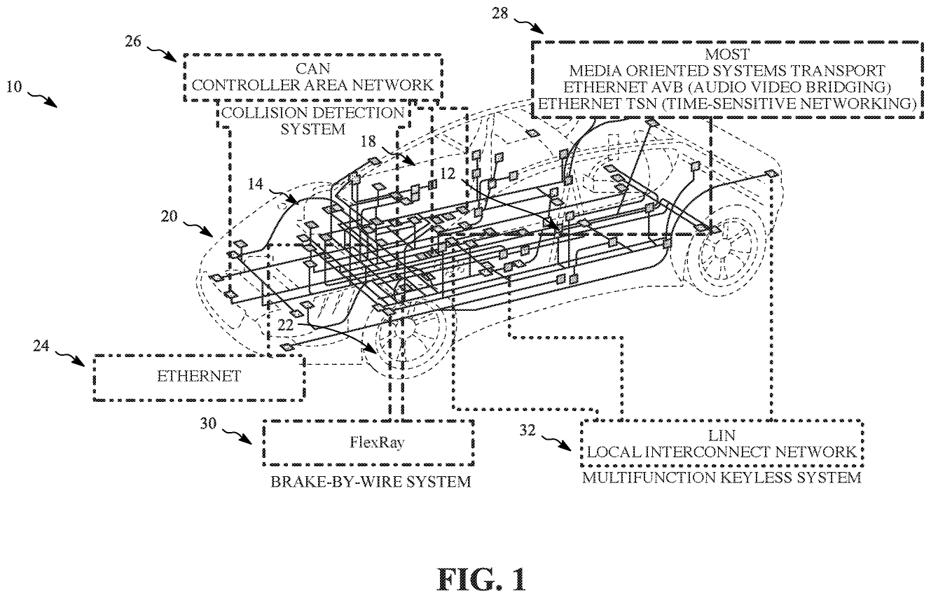

FIG. 1 generally illustrates a vehicle 10 according to the principles of the present disclosure. The vehicle 10 may include any suitable vehicle, such as a car, a truck, a sport utility vehicle, a mini-van, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as ATVs, planes, boats, trains, drones, or other suitable vehicles.

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on a rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a steering wheel, and other such components are disposed in the passenger compartment 18 of the vehicle 10. The propulsion controls may be actuated or controlled by a driver of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive-by-wire), or autonomous controller, which in turn may control the corresponding propulsion component of the propulsion system. As such, in some embodiments, the vehicle 10 may be an autonomous vehicle.

In some embodiments, the vehicle 10 may include an Ethernet component 24, a controller area network component (CAN) 26, a media oriented systems transport component (MOST) 28, a FlexRay component 30 (e.g., brake-by-wire system, and the like), and a local interconnect network component (LIN) 32. The vehicle 10 may use the CAN 26, the MOST 28, the FlexRay Component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22. The vehicle 10 may be an autonomous or semi-autonomous vehicle, or other suitable type of vehicle. The vehicle 10 may include additional or fewer features than those generally illustrated and/or disclosed herein.

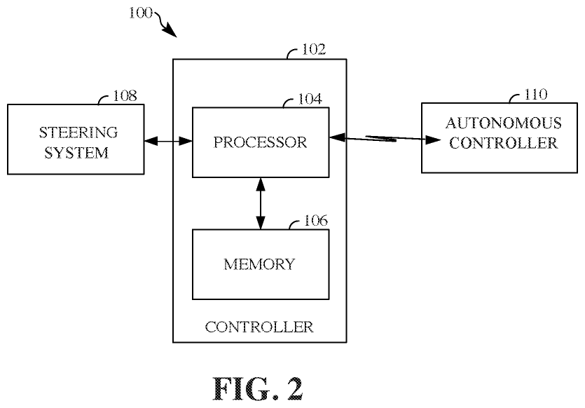

The vehicle 10 may include a system 100, as is generally illustrated in FIG. 2. The system 100 may include a controller 102. The controller 102 may include an electronic control unit or other suitable vehicle controller. The controller 102 may include a processor 104 and memory 106 that includes instructions that, when executed by the processor 104, cause the processor 104 to, at least, provide autonomous control of the vehicle 10. The processor 104 may include any suitable processor, such as those described herein. The memory 106 may comprise a single disk or a plurality of disks (e.g., hard drives), and includes a storage management module that manages one or more partitions within the memory 106. In some embodiments, memory 106 may include flash memory, semiconductor (solid state) memory or the like. The memory 106 may include Random Access Memory (RAM), a Read-Only Memory (ROM), or a combination thereof.

The system 100 may include a steering system 108 configured to assist and/or control steering of the vehicle 10. The steering system may be an electronic power steering (EPS) system or a steer-by-wire system. The steering system may include or be in communication with various sensors configured to measure various aspects of the steering system of the vehicle 10. The steering system may include various controllers, memory, actuators, and/or other various components in addition to or alternatively to those described herein. The steering system 108 may be configured to measure and communicate with the controller 102, or more specifically, with the processor 104. In some embodiments, the system 100 may omit the steering system 108. For example, the system 100 may include or be in communication with an autonomous steering system (e.g., no steering wheel or EPS system), or may include any other suitable system in addition to or instead of the steering system 108. In certain embodiments, an autonomous controller 110 providing autonomous control of the vehicle 10 may be configured to communicate with the controller 102 (e.g., to the processor 104) autonomous controls of the vehicle 10.

In some embodiments, the system 100 may control autonomous operation of the vehicle 10 before, during, and after autonomous travel of the vehicle 10 in a route. The route may be a path of travel of the vehicle 10, or any other location of the vehicle 10. In autonomous operation, the processor 104 may identify a signal representative of a data input of a route of autonomous travel by a vehicle 10. The data input may be any condition of the environment proximate to the vehicle. For example, the data input may represent identification of a pothole, object, pedestrian, flow of traffic, or road surface conditions, etc. In some embodiments, the processor 104 may identify the data input (e.g., condition) by receiving a signal representative of the data input from the autonomous controller 110, an image-capturing device, or other sensors.

In some embodiments of autonomous operation, the processor 104 may identify a data input representative of a driver input. In some embodiments, the data input may be a preference of a driver for autonomous travel of the vehicle 10. For example, the driver may desire to alter the route of autonomous travel of the vehicle 10 based on the proximity of another vehicle 10, such as a motorcycle, to change lanes, or take other actions. The driver may communicate such desire to the system 100 by actuating the steering wheel according to predefined gestures.

The predefined gestures may include actuating the steering wheel to the right or left; applying more or less torque to the steering wheel, and the like. In some embodiments, the autonomous controller 110 may receive a signal representative of the driver input and determined whether vehicle 10 travel based on the driver input is safe, among any other parameter (e.g. most efficient route to get to destination). If the autonomous controller 110 determines that vehicle 10 travel based on the driver input should be taken, the autonomous controller 110 may accommodate the driver input for vehicle 10 travel.

In some embodiments, the autonomous controller 110 may store information corresponding to the driver input. For example, the system 110 and/or autonomous controller 110 may identify like characteristics of the operations of the vehicle 10 based on the driver input. The system 100 may store the characteristics and, in response to identifying similar characteristics during a subsequent operation of the vehicle 10, the autonomous controller 110 may adjust operations of the vehicle 10 to accommodate the driver preference. For example, the system 100 may identify a relationship between the driver input and the proximity of another vehicle, such as a motorcycle, to change lanes, or make another action.

In some embodiments, the processor 104 may receive a first autonomous action for controlling autonomous travel of the vehicle 10. In some embodiments, the processor 104 may receive the first autonomous action by receiving a signal representative of the first autonomous action from the autonomous controller 110 or from the steering system 108. In either event, the first autonomous action is determined based on the data input, determined by the autonomous controller 110 or by the driver. The processor 104 may determine, by processing the signal representative of the first autonomous action, a second autonomous action based on the data input for controlling autonomous travel of the vehicle 10. In some embodiments, the second autonomous action includes at least one steering maneuver.

During autonomous travel of the vehicle 10 on a route, e.g., a roadway, the steering system 108 (or autonomous controller 110) may rely on signals from the driver (e.g., via an input to the steering or hand wheel) an image-capturing device, or other sensor, to monitor and analyze the environment proximate to the vehicle 10 in real-time. For example, the system may be configured to monitor for potholes, objects, pedestrians, flow of traffic, or road surface conditions, etc. Accordingly, the steering system 108, or driver input, sends a signal (e.g., the first autonomous action) to the processor representative of a condition of the environment proximate to the vehicle 10 and the pending autonomous travel of the vehicle 10. The processor 104 may processes the signal and determine the best autonomous action (e.g., steering maneuver) is to proceed with the pending autonomous travel despite the environmental condition (e.g., a small tree branch). In such a situation, the first autonomous action would represent a signal to the steering system 108 to maintain the wheels 22 on course. If the processor 104 determines an alternative autonomous action (e.g., steering maneuver) based on the environmental condition may be advantages, the second autonomous action may represent a signal to the steering system 108 to maneuver the wheels 22 to change the pending autonomous travel (i.e., route).

The processor 104 will determine the best or safest autonomous action for the vehicle 10. For example, if the processor 104 determines a first environmental condition (e.g., the small tree branch) may scratch the vehicle 10 but does not present a hazardous condition to the driver and that a second environmental condition (e.g., a tree) may present a hazardous condition to the driver, the processor 104 will select the rout presenting no hazardous condition to the driver. In another embodiment, the system 100 may communicate with a driver of the vehicle 10 to provide a feeling of autonomy over the vehicle 10 to the driver. For example, if the processor 104 determines the first environmental condition (e.g., the small tree branch) may scratch the vehicle but does not present a hazardous condition to the driver the processor 104 may prompt the driver to indicate if the vehicle 10 should proceed over the branch (e.g., first autonomous action), or change its rout by taking the second autonomous action. If a second environmental condition (e.g., a pedestrian) presents a hazardous condition if the second autonomous action is selected and where to be taken, the processor 104 will dismiss the selection, and proceed with the safest autonomous action. In some embodiments, the processor 104 may generate a selectable output that includes the first autonomous action (e.g., run over the tree branch) and the second autonomous action (e.g., maneuver around the tree branch). In no event, however, does the driver selection provide control of the vehicle 10. The system 100 will continuously monitor, in real time, the best or safest autonomous action for the vehicle 10. The selectable output may be a visual, audible, or tactile output.

The processor 104 may communicate a signal to a display (e.g., visual output) of the system 100 where the display present to the driver images representative of first and second autonomous actions. The display may provide the driver with an option to select one of the images, or the first or second autonomous actions. The display may indicate the driver take a certain action, such as with the steering wheel or touch within the display to make a selection of the first or second autonomous actions. In another example, the processor 104 may communicate a signal to lights (e.g., visual output) of a steering wheel of the system 100 where the lights illuminate in a representative pattern for the first and second autonomous actions, and an action to be taken to select the first or second autonomous action. In another example, the processor 104 may communicate a signal (e.g., audible output) to an audible output device (e.g., a speaker) of the system 100 where the audible output device announces options representative of first and second autonomous actions. In yet another example, the processor 104 may communicate a signal to cause movement of the steering wheel, e.g., tactile output, in a representative of the first and second autonomous actions. Of course, it is to be appreciated there are any number of ways to provide visual, audible, or tactile output to a driver of the vehicle 10 that fall within the scope of the present disclosure.

In some embodiments, the processor 104 receives an input indicating a selected one of the first autonomous action and the second autonomous action. In some embodiments, the processor 104 may receive a signal from an input device, where the signal is representative of the driver's selection of the first or second autonomous actions. The input device may be a display, microphone or a retina scanner, among others. The input device may be configured to communicate with the system 100, and may be disposed within the vehicle 10 or integrated in a mobile computing device (e.g., a smart phone or tablet computing device, or other suitable location). In embodiments where the input device is a display, the display may present a representative image of the first or second autonomous actions for selection by the driver. In some embodiments, the driver may select a representative image, and in turn, the first or second autonomous actions, by touching a representative image in the display (e.g., tactile input) by touching an image in the display. In other embodiments, the driver may select a representative image associated with a verbal communication and the first or second autonomous actions by speaking the verbal communication (e.g., audible input) to a speaker. In other embodiments, the driver may select a representative image associated with a visual communication and the first or second autonomous actions by the driver providing a visual communication (e.g., biometric input) to a retina scanner. Of course, it is to be appreciated there are any number of ways to provide visual, audible, or biometric, among other, inputs within the scope of the present disclosure.

In some embodiments, the processor 104 may selectively controls autonomous travel of the vehicle 10 based on the selected one of the first autonomous action and the second autonomous action. In some embodiments, the processor 104 may provide a signal to the steering system 108 to perform a certain autonomous action (e.g., a steering maneuver) based on the selected one of the first autonomous action and the second autonomous action. In some embodiments, processor 104 provides instructions to an autonomous controller 110 of the vehicle 10 based on the selected one of the first autonomous action and the second autonomous action. The autonomous controller 110, based on the instructions from the processor 104, may control operation of the vehicle 10 based on the selected one of the first autonomous action and the second autonomous action.

The processor 104 and/or autonomous controller 110, in real time, determines the selected one of the first autonomous action and the second autonomous action to ensure the selected one of the first or second autonomous action is still the safest and most efficient travel route for the vehicle 10. For example, the processor 104 may receive a signal indicating the selected one of the first autonomous action or the second autonomous action. If the processor 104 receives the signal, the processor 104 determines that the driver selected the one of the first autonomous action or the second autonomous action. Conversely, if the processor 104 does not receive the signal, the processor 104 determines the driver did not make a selection. If the processor determines the driver did not make a selection, the processor 104 and/or the autonomous controller processes according to the safest and most efficient travel route of the vehicle 10. Accordingly, although the driver may be providing selection, the selection does not affect the autonomous control of the vehicle 10.

In some embodiments, the system 100 may perform the methods described herein. However, the methods described herein as performed by system 100 are not meant to be limiting, and any type of software executed on a controller can perform the methods described herein without departing from the scope of this disclosure. For example, a controller (or autonomous controller), such as a processor executing software within a computing device, can perform the methods described herein.

FIG. 4 is a flow diagram generally illustrating an autonomous vehicle control method 300 according to the principles of the present disclosure.

At step 302 the method 300 identifies at least one data input of a route of autonomous travel by a vehicle 10. For example, the processor 104 may identify the data input by receiving a signal representative of the data input from the autonomous controller 110, an image-capturing device, or other sensors. In some embodiments, the method 300 identifies at least one data input of a route of autonomous travel by a vehicle 10 by identification of a signal from the driver, or another user, representative of an input of the at least one data input of a route of autonomous travel. In some embodiments, the at least one data input of a route of autonomous travel by the vehicle 10 may be based on a preference of a user for autonomous travel of the vehicle 10.

At step 304, the method 300 receives a first autonomous action for controlling autonomous travel of the vehicle 10, the first autonomous action being determined based on the at least one data input. For example, the processor 104 may receive a first autonomous action for controlling autonomous travel from the autonomous controller 110. At step 306, the method determines a second autonomous action for controlling autonomous travel of the vehicle 10 based on the at least one data input. For example, the processor 104 may determine a second autonomous action based on the first route data input. The second autonomous action may include at least one steering maneuver.

At step 308, the method generates a selectable output that includes the first autonomous action and the second autonomous action. For example, the processor 104 may generate a selectable output that includes the first autonomous action and the second autonomous action. The selectable output may be an audible output, a visual output, a tactile output, haptic output, any other suitable output, or a combination thereof.

At step 310, the method receives an input signal corresponding to a selected one of the first autonomous action and the second autonomous action. For example, the processor 104 may receive an input signal indicating a selected one of the first autonomous action and the second autonomous action. The input signal may correspond to an audible input, a tactile input, biometric input, any other suitable input, or a combination thereof.

At step 312, the method controls autonomous vehicle travel based on the selected one of the first autonomous action and the second autonomous action. For example, the processor 104 may control autonomous vehicle travel based on the selected one of the first autonomous action and the second autonomous action.

In some embodiments, the method 300 may provide instructions to a steering system to perform a steering maneuver. In some embodiments, the method may determine an autonomous action based on the selected one of the first autonomous action and the second autonomous action. In some embodiments, the selected one of the first autonomous action and the second autonomous action may include the non-selection of the first autonomous action or the second autonomous (e.g., no input from the driver is received). The autonomous action may be one of (a) the first autonomous action, (b) the second autonomous action, or (c) another autonomous action. For example, the processor 104 may provide instructions to the steering system 108 to perform a steering maneuver.

In some embodiments, the method may provide instructions to an autonomous controller of the vehicle 10 based on the selected one of the first autonomous action and the second autonomous action. For example, the processor 104 may provide instructions to the autonomous controller 110 to perform the steering maneuver of the second autonomous action. In some embodiments, the method may determine an alternative autonomous action after receiving, or not receiving, the selected one of the first autonomous action and the second autonomous action, and provide instructions based on the alternative autonomous action.

In some embodiment, a system for providing autonomous control of a vehicle includes a processor and a memory. The memory includes instructions that, when executed by the processor, cause the processor to: identify at least one data input of a route of autonomous travel by a vehicle; receive a first autonomous action for controlling autonomous travel of the vehicle, the first autonomous action being determined based on the at least one data input; determine a second autonomous action for controlling autonomous travel of the vehicle based on the at least one data input, the second autonomous action including at least one steering maneuver; generate a selectable output that includes the first autonomous action and the second autonomous action; receive an input indicating a selected one of the first autonomous action and the second autonomous action; and selectively control autonomous travel of the vehicle based on the selected one of the first autonomous action and the second autonomous action.

In some embodiments, the instructions of the system may cause the processor to provide instruction to a steering system to control travel of the vehicle based on the selected one of the first autonomous action and the second autonomous action. In some embodiments, the instructions of the system may cause the processor to provide instructions to an autonomous controller of the vehicle based on the selected one of the first autonomous action and the second autonomous action. In some embodiments, the autonomous controller controls operation of the vehicle based on the selected one of the first autonomous action and the second autonomous action. In some embodiments, the selectable output includes an audible, visual, or tactile output. In some embodiments, the instructions further cause the processor to receive an input signal corresponding to an audible, tactile or biometric input indicating a selected one of the first autonomous action and the second autonomous action.

In some embodiments, a method is for providing autonomous control of a vehicle, the method comprising: providing a processor and memory including instructions, providing instructions to the processor, initiating, by the processes and based on one or more of the instructions, the steps comprising: identifying at least one data input of a route of autonomous travel by a vehicle; receiving a first autonomous action for controlling autonomous travel of the vehicle, the first autonomous action being determined based on the at least one data input; determining a second autonomous action for controlling autonomous travel of the vehicle based on the at least one data input, and the second autonomous action including at least one steering maneuver; generating a selectable output that includes the first autonomous action and the second autonomous action; receiving an input signal corresponding to a selected one of the first autonomous action and the second autonomous action; and controlling autonomous vehicle travel based on the selected one of the first autonomous action and the second autonomous action.

In some embodiments, the method comprises initiating step further comprises providing instructions to a steering system to perform a steering maneuver. In some embodiments, the method comprises providing instructions to an autonomous controller of the vehicle based on the selected one of the first autonomous action and the second autonomous action. In some embodiments of the method, the selectable output includes an audio, visual or tactile output. In some embodiments of the method, the input signal corresponds to an audio, tactile, or biometric input indicating a selected one of the first autonomous action and the second autonomous action.

In some embodiments, an apparatus provides autonomous control of a vehicle. The apparatus may comprise a controller that includes: a processor; and a memory including instructions that, when executed by the processor, cause the processor to: identify at least one data input of a route of autonomous travel by a vehicle; receive a first autonomous action for controlling autonomous travel of the vehicle, the first autonomous action being determined based on the at least one data inputs; determine a second autonomous action for controlling autonomous travel of the vehicle based on the at least one data input, and the second autonomous action including at least one steering maneuver; generate a selectable output that includes the first autonomous action and the second autonomous action to an occupant of the vehicle; receive an input from the occupant including a selected one of the first autonomous action and the second autonomous action; selectively control autonomous vehicle operation based on the selected one of the first autonomous action and the second autonomous action; and provide instructions to an autonomous controller of the vehicle based on the selected one of the first autonomous action and the second autonomous action.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation to encompass all such modifications and equivalent structure as is permitted under the law.

Having thus described the invention, it is claimed:

1. A system for providing autonomous control of a vehicle, the system comprising:
a processor; and
a memory including instructions that, when executed by the processor, cause the processor to:
identify at least one data input of a route of autonomous travel by a vehicle;
receive a first autonomous action for controlling autonomous travel of the vehicle, the first autonomous action being determined based on the at least one data input;
determine a second autonomous action for controlling autonomous travel of the vehicle based on the at least one data input, the second autonomous action including at least one steering maneuver;
generate a selectable output that includes the first autonomous action and the second autonomous action;
receive an input indicating a selected one of the first autonomous action and the second autonomous action; and
selectively control autonomous travel of the vehicle based on the selected one of the first autonomous action and the second autonomous action.

2. The system of claim 1, wherein the instructions further cause the processor to provide instructions to a steering system to control travel of the vehicle based on the selected one of the first autonomous action and the second autonomous action.

3. The system of claim 1, wherein the instructions further cause the processor to provide instructions to an autonomous controller of the vehicle based on the selected one of the first autonomous action and the second autonomous action.

4. The system of claim 3, wherein the autonomous controller controls operation of the vehicle based on the selected one of the first autonomous action and the second autonomous action.

5. The system of claim 1, wherein the selectable output includes one of an audible output, a visual output and a tactile output.

6. The system of claim 1, wherein the instructions further cause the processor to receive an input signal corresponding to an audible input indicating a selected one of the first autonomous action and the second autonomous action.

7. The system of claim 1, wherein the instructions further cause the processor to receive an input signal corresponding to a tactile input indicating a selected one of the first autonomous action and the second autonomous action.

8. The system of claim 1, wherein the instructions further cause the processor to receive an input signal corresponding to a biometric input indicating a selected one of the first autonomous action and the second autonomous action.

9. The system of claim 1, wherein the identification of the at least one data input comprises identification of a driver input.

10. The system of claim 9, wherein the driver input is a preference of a driver for autonomous travel of the vehicle.

11. A method for providing autonomous control of a vehicle, the method comprising:
providing a processor and memory including instructions,
providing instructions to the processor,
initiating, by the processes and based on one or more of the instructions, the steps comprising:
identifying at least one data input of a route of autonomous travel by a vehicle;
receiving a first autonomous action for controlling autonomous travel of the vehicle, the first autonomous action being determined based on the at least one data input;
determining a second autonomous action for controlling autonomous travel of the vehicle based on the at least one data input, and the second autonomous action including at least one steering maneuver;
generating a selectable output that includes the first autonomous action and the second autonomous action;
receiving an input signal corresponding to a selected one of the first autonomous action and the second autonomous action; and
controlling autonomous vehicle travel based on the selected one of the first autonomous action and the second autonomous action.

12. The method of claim 11, wherein the initiating step further comprises providing instructions to a steering system to perform a steering maneuver.

13. The method of claim 11, wherein the initiating step further comprises providing instructions to an autonomous controller of the vehicle based on the selected one of the first autonomous action and the second autonomous action.

14. The method of claim 11, wherein the selectable output includes one or more of an audible output, visual output and tactile output.

15. The method of claim 11, wherein the input signal corresponds to an audio input indicating a selected one of the first autonomous action and the second autonomous action.

16. The method of claim 11, wherein the input signal corresponds to a tactile input indicating a selected one of the first autonomous action and the second autonomous action.

17. The system of claim 11, wherein the input signal corresponds to a biometric input indicating a selected one of the first autonomous action and the second autonomous action.

18. The method of claim 11, wherein the identification of the at least one data input of a route of autonomous travel by the vehicle comprises identification of a signal representative of a driver input.

19. The method of claim 18, wherein the driver input is a preference of the driver for autonomous travel of the vehicle.

20. An apparatus for providing autonomous control of a vehicle, the apparatus comprising:
a controller that includes:
a processor; and
a memory including instructions that, when executed by the processor, cause the processor to:
identify at least one data input of a route of autonomous travel by a vehicle;
receive a first autonomous action for controlling autonomous travel of the vehicle, the first autonomous action being determined based on the at least one data input;
determine a second autonomous action for controlling autonomous travel of the vehicle based on the at least one data input, and the second autonomous action including at least one steering maneuver;
generate a selectable output that includes the first autonomous action and the second autonomous action to an occupant of the vehicle;
receive an input from the occupant including a selected one of the first autonomous action and the second autonomous action;
selectively control autonomous vehicle operation based on the selected one of the first autonomous action and the second autonomous action; and
provide instructions to an autonomous controller of the vehicle based on the selected one of the first autonomous action and the second autonomous action.
